(19) United States
(12) Patent Application Publication
(10) Pub. No.: US 2003/0046176 A1
(43) Pub. Date: Mar. 6, 2003

(54) One page purchasing system

(76) Inventor: Harold F. Hynes, Atwood, KS (US)

Correspondence Address: Harold F. Hynes, 109 S. 5th St., Atwood, KS, 67730, US

(21) Appl. No.: 09/945,467

(22) Filed: Sep. 4, 2001

(51) Int. Cl. G06F 17/60

(52) U.S. Cl. 705/26

(57) ABSTRACT

The system is designed to cover about 30 steps of purchasing for the buying company, using a single document which moves electronically through these steps to accomplish the necessary action, in a tracked system. This is done without human intervention except for preparation of the document, acknowledging receipt of the merchandise, and having spot security and audit checks of its performance. An electronic program extends the system to deposit the payment due, into the bank account of the vendor. Electronic signatures and/or the invoice number assigned and inserted in the document by the vendor, are required to prove completion of each key step in the process. Control is shifted to the buyer paying from the one page document, and not from vendors' invoices and statements which require verification. Benefits result from the elimination of conventional purchase requisitions, purchase orders, shipping documents, vendors invoices, vendors statements, and payment checks. This reduces errors, processing delays, employees' time and materials used,—and provides very substantial dollar savings for the purchaser, vendor and bank.

### BACKGROUND OF THE INVENTION

Every employee or group of employees of an organization requires materials from outside vendors for new, continuing, or replacement uses, in performing their jobs This process of 30 or more steps is capsuled as (1) identifying and justifying the need, (2) selecting the vendor, (3) communicating the need to the vendor, (4) receiving the materials ordered, and (5) paying the vendor. A listing of convential purchasing functions is shown at the end of this section. Materials can range from inexpensive office supplies to production items and expensive equipment. They may be treated as an expense for inclusion in the profit and loss statement, or capitalized as a fixed asset, or shown on the balance sheet as inventory.

As an organization grows in numbers of employees, management controls in the form of policies and procedures become more exacting, and the increased volume of purchasing becomes the responsibility of experienced full time purchasing people. These directions entail formal systems and procedures to assure that the organization gets the right: item, quantity, quality, price, timing, warranty, credit terms and sources, with the right cost of purchasing. Sometimes such services become ineffective and need correction.

TRADITIONAL SYSTEMS have approval limits assigned to specific jobs which are observed by the require in preparing a purchase requisition. The requisition goes to a specialist in the purchasing department who lends his talent to the “right” requirements and prepares a purchase order sent to the vendor. If required, vendor acknowledges the order. Vendor sends the item ordered to the organization's receiving department, along with a shipping document. Receiving checks the contents against the document list and sends the item to the require. An invoice, showing the amount due is received from the vendor and is checked for accuracy and matched against the purchase order. These are matched against an advice from the require that the proper items were received and should be paid for. Accounting entries are made to charge the items and credit accounts payable. Instructions to make payment are sent to the “payment department”. A monthly statement is received from the vendor listing the invoice and any others received. The invoices approved are checked against the statement. Upon approval, a check is prepared and sent to the vendor. Accounting entries are made to accounts payable and cash.

KEY ACTION POINTS which require approval or completion are (1) authorized approval of purchase requisition, by require, (2) approval of purchase order sent vendor, (3), acknowledge by vendor (if requested), or acceptance of order by vendor, (4) receipt of material by receiving department, (5) receipt of material by require, (6) approval for payment, and (7) check signed.

DOCUMENTS are prepared to: (1) provide guidelines for purchasing, (2) justify the purchase, if required, and are (3) purchase requisitions, (4) purchase orders, (5) vendor acknowledgments or acceptances, (6) shipping documents, (7) receipts by receiving department, (8) advices to require, (9) approvals of require, (10) approvals of invoice, (11) approvals of statement, (12) preparations of check, (13) making accounting entries, and (14) bank statements. Some of these are being performed electronically and some steps may be voided when the size, type and frequency of orders permits.

ERRORS, TIME DELAYS AND HIGH COSTS are encountered in existing systems as a result of transferring and verity data from one document to another, handling paper work, creating massive files and unnecessary costs of all these steps, plus possible excessive purchase prices. Also, invoices and vendor statements may include items not yet received.

SUMMARY OF THE INVENTION describes the methods and systems for solving these problems.

### CONVENTIONAL PURCHASING FUNCTIONS

A. Introduce purchasing policies and procedures including security and scheduling controls B. For each item(s) to be ordered:

1. Establish need

2. Meet company objectives

3. Assure money available

4. Secure necessary approval

5. Determine:

a. Right item

b. Right quantity

c. Right quality

d. Right price

e. Right timing

f. Right warranties

g. Right credit terms

h. Right source

6. Place order with vendor

7. Secure confinrmation (if necessary)

8. Be advised of delivery date (if necessary)

9. Receive item and packing document

10. Verify quantity and acceptability of item from packing document

11. Send item to user or inventory location

12. Compare item or packing document to purchase order

13. Receive vendor's invoice

14. Invoice recipient compares invoice with purchase order

15. Recipient checks addition on invoice

16. Accounts payable is set up for amount due vendor

17. Charges are made to asset or expense accounts

18. Vendor's statement is received

19. Vendor's invoices are checked against statement

20. Payment is scheduled

21. Check is prepared and sent vendor

22. Accounting entries are made to cash and accounts payable

23. Make any necessary disposition of items replaced

24. Fixed asset items are physically numbered, if necessary—with control list

25. Depreciation is set up for new fixed asset items

26. Depreciation of any fixed assets replaced is processed.

27. Accounting cutoff dates are made available

28. Audit and security trails are applied

29. Backup file provided for “lost” documents.

### SUMMARY OF THE INVENTION

The system is designed to cover the 30 steps of purchasing for the buying company, using a single document which moves through these steps to accomplish the necessary actions in a tracked system. This is done electronically without human intervention except for preparation of the order, acknowledging receipt of the merchandise, and having spot security and audit checks of its performance. An electronic program extends the system to deposit the payment due, into the bank account of the vendor.

Three methods of purchasing for commercial organizations are embodied in the ONE PAGE PURCHASING SYSTEM. One for all orders over a fixed dollar amount, except for contract orders, is called Purchase Documents (PD). Another is for the contract orders; called Contract Purchases (CP). The third is for purchases less than the fixed amount, called, Purchase Short Orders (PSO). The last two, with proper approval can be ordered directly by the require, from the vendor, following the procedures outlined here. The PD method requires processing through the purchasing department. All three methods are performed and communicated through the use of electronic devices, such as computers. In the preparation stages of the order on the computer, use is made of a Purchase Resources program available by using computer windows. A permanent Purchase Tracking and Action System (PTA) is used at the time of ordering which sets up the order with expected dates of action and instructions for computer actions to complete the necessary computer steps, along with a signal for necessary follow-up. Similarly, a storage file system is used in the event of a computer breakdown.

All three methods will eliminate the conventional purchase requisitions, purchase orders, shipping documents, vendors invoices and statements. This is achieved by the buyer using one of the three order forms described here for each of the three methods, which shows the exact total cost to be paid the vendor. In addition, a Purchase Worksheet used in the computer may facilitate preparation of the order. When the order is signed and given a number, the PTA starts processing and tracking the order. The PTA Emails the order to the vendor who confirms the order and amount by electronically signing the form and/or just assigns an invoice number and inserts it in the document as prescribed, Emailing it back to the PTA,—either as a confirmation of the order or when the shipment is being sent, or both. The PTA sends the acknowledged order to receiving putting them on notice for a scheduled delivery, with an expected date of delivery for follow up. When the item is shipped, the vendor prints a bar coded label with the buyer's order number, and the vendor's “invoice” number, which is attached to the package. Upon receipt, by the receiving department, the label is read to produce a copy of the order on a hand held computer reader to check receipt of the items ordered, thereby eliminating the need for a shipping document from the vendor and not have to verify a shipping document against the order. The receiving person electronically signs the order and sends it to PTA for updating the tracking system The PTA sends it to the require which is advising them that the package has arrived and will be available. The require upon receipt, electronically signs the order and returns it to the PTA which has a waiting date for follow up. PTA will carry the order as an open document at all times, and as actions are completed, they will be verified for correctness and completeness. PTA begins activating each order immediately upon the first approval by the requirer, and continues to move and keep track of the order through to its last step in the process. The document is used to recognize the successive steps and when each step is completed, the person, responsible, will click the cursor in the circle for the next action, showing a dot in the circle, which moves it to the next step.

If he cannot comply with the order, or doesn't understand it, he will delete the dot in the circle which directed the action to him, and also the dot in the circle which preceded his own circle. This will automatically produce a form on his computer called, Action Change Request. (ACR), which he can use to explain the problem and possible solution. He will click the preceding circle to send it back to the previous step for action. This will put the system on notice that a delay is in process and set a follow up date by PTA. Similarly the action will continue to reverse until the right person takes the necessary action. Then it goes back on track.

In taking the successive steps covered by the document, requiring approvals, dates, etc. such preexisting items will be locked in on the document and not available for change by the new recipient, and can only be changed by the previous recipient for his participation.

Requirer's final approval, clicking for the next action leads to an automatic electronic set of payment procedures, using the payment directions in the system, but also shown on the document. Upon setting up the payment schedule and also making the payment through the bank, the scheduled dates will be filled in electronically and the circles for each will show a dot to verify on the document that these steps have been taken, as scheduled.

The accounting entries coupled with these transactions closely mirror actual receipts of items and the details shown on the order is a quick and complete record of the transactions for ready reference and use in checking security and auditing.

The PTA will follow its computer program for making the accounting entries of charges and accounts payable, and add the total amount of each order to a 30 day accumulation of orders in the vendor's account, showing order number, invoice number and amount for each order. A payment schedule will be arranged in advance with the vendor to pay the 30 day total on a certain date in order to spread payments for all the vendors, to meet cash needs. The vendors would be paid from a special vendors payment bank account, sent directly by wire to the vendors bank accounts Large buyers would continually be on line with their bank to process payments to vendors by wire, as scheduled. The smaller volume companies can use a Remittance Sheet. Daily, PTA will Email a Remittance Sheet listing the payments for all scheduled vendors, to the buyer's bank, for them to wire these amounts to the respective vendors' banks, using the vendors banks' deposit codes supplied with the list.

The online bank service would send a daily confirmation of scheduled payments completed, to the purchaser. In the case of a Remittance Sheet, the buyer's bank Emails the Remittance Sheet back to the treasurer's Vendors Payment Computer System (TC) after inserting the reference number of the wires sent each vendor's bank, with a signature of confirmation.—along with a daily cash statement showing a summary of the cash transactions and cash balances in this special vendor payment account. Upon electronically reconciling the account, TC will use this as a basis for accounting entries to accounts payable and cash, with supporting entries in each vendor's account. Similarly, on line service would use cutoff points to effect the same results These single payments to each vendor will be confirmed to the vendor by TC Emailing a vendor's statement listing the orders and invoice numbers, and amounts, with the wire number. This replaces receiving and processing a statement from the vendor and proving the merchandise being received, (and not always received before being invoiced). The system pays on the basis of items received

TC will complete the individual orders by entering the dates of payment, payment reference and the amount paid. The order will be filed by its number and vendor's name and number of invoice. The vendor's statement will be filed by vendor's name, reference number and dates. These will go into a semipermanent file with a retention period and the permanent file will be updated similarly. Any failure in the system, such as a lack of signature or delays win cause a return of the order to the previous action point, and uncorrected situations will return to the purchasing department (or requirer) to handle personally when a time limit is exceeded.

The special vendor payment bank account would be carried as an imprest fund. Enough balance would be maintained to justify the “free” service charges for processing vendor payments. At periodic dollar points, sufficient amounts would automatically be transferred from a general account to cover the payments disbursed, and shown in the continuing available cash report.

The above basic steps apply to all three purchasing methods, but the method for items Over a Given Amount (PD) requires greater attention to the justification for the items order, and the care taken to secure the right requirements. These can be incorporated in the PTA system and be made a more identifiable supplement to the Purchase Document (PD), as the Purchase Worksheet (PW) for either fixed assets or expense items. It would originate with the requirer along with the PD, and provide the basis for working with the purchasing department to produce a PD to send the vendor. The purchasing department would add (PW) as a supplement number to the PD number and this would only be accessed by the requirer, the purchasing department, or the security and auditing people, but it would accompany the PD as part of the data base semi-permanent and permanent files.

For those repeated Contract Purchases from specific vendors to keep the production line flowing, use of the one page system has an advantage over just supplying the vendor with production schedules as a basis for sending merchandise. It keeps a tighter control of orders and payments for the buyer. Orders can be prepared and sent Email automatically with preparation of production schedules, and the order form remains a direct control over receipt of merchandise and payment for individual shipments, as described here.

Eliminating the several documents, with performing the same functions, using electronics, will have major benefits of reducing human errors, time delays, manhours, machine time, and very substantially reduce costs of purchasing and administrative problems. Responsibility for recognizing the amount due would rest with the purchaser, as arranged with the vendors, who also will benefit from these arrangements, including getting paid sooner. A list of profitable features of the One Page Purchasing System is included in this section.

Purchasing guidelines and authorization limits would be available in the computer, plus having product and vendor catalogues, cost data and necessary information on the vendors.

The steps described above are detailed in the following flow charts with suggested forms, and are complemented by a listing of computer software programs for the purchasing system.

### Profitable Features of the One Page Purchasing System

### For the Purchaser, Vendor and the Bank

The Purchaser

( ) Eliminates processing small orders through the purchasing department.

( ) Elihmines handling and mailing of purchase orders to the vendor

( ) Eliminates verifying confirmation of orders to the purchase order.

( ) Eliminates receipt and handling of vendor's invoice.

( ) Eliminates the need to compare invoice to the purchase order.

( ) Eliminates the need to compare items received to the invoice.

( ) Eliminates the need to compare invoiced prices and additions to the purchase order.

( ) Eliminates the receipt and handling of vendor's statement.

( ) Eliminates comparing the invoices with the statement.

( ) Eliminates the receipt and handing of packing ticket.

( ) Eliminates the need to physically follow up on orders pending,

( ) Eliminates the need to physically arrange payment to vendor.

( ) Eliminates preparation of checks to pay the vendor.

( ) Eliminates sending check to vendor.

( ) Eliminates physical preparation of accounting entries.

The Vendor

( ) Electronically uses the Purchase Document to set up their production and shipping requirements.

( ) Eliminates need to prepare a confirmation of the order.

( ) Eliminates preparation and handling an invoice.

( ) Eliminates preparation and handling of a statement

( ) Eliminates preparation and handling of a shipping document.

( ) Relies on payment schedule agreed upon with purchaser.

( ) Eliminates receipt and processing of payments.

( ) Speeds up receipt of payment in bank account.

( ) Receives a record of invoices paid from the purchaser.

( ) Automatically records sales, billing and payments from purchase documents, shipments, and payments.

The Bank

( ) Eliminates the need for processing purchaser's checks.

( ) Secures a compensating balance for processing payments, or a fee.

( ) Automatically secures funds transferred to maintain balances needed.

( ) Has possibility of securing accounts from vendors.

Note: As the obvious advantages of the coordination of these functions become widespread, it will continue to increase the dollar savings to the participants

### Computer Programs for the One Page Purchasing System

The System introduces a one page document to replace:

A purchase requisition—requesting a purchase order for merchandise needed

A purchase order—to place an order with a vendor

A delivery document accompanying shipment, for verifying contents

A vendor's invoice received by the buyer to make payment And

The monthly statement received from the vendor would be eliminated

This document would travel electronically to each action location—being electronically signed at each point when action is completed, or vendor approved by assigning an invoice number on the document, and moved to the next location. Related steps would be initiated by the computer to take other completed orders with the same vendor and make necessary payments and accounting entries, etc. based on items received.

Computer programs to be made part of the system are grouped here as:

A. Resources

B. The “One Page” Purchase Tracking and Action System

C. Vendor Payments

D. Permanent and Storage Files

E. Security and auditing

F. Management Reports

A. RESOURCES—would include the following information available in the computer.

1. Description of company's purchasing policies and procedures

2. Schedule of authorization limits

3. Accounting for new and retired fixed assets

4. Accounting for expense items

5. List of idle equipment available in the company

6. List of customary vendor sources, etc.

7. Vendors catalogues, prices and shipping data

8. List of shippers

9. Shipping and handling charges

10. List of company contracts

11. Receiving locations

12. Other resources

B. The One Page Purchase and Tracking System

The computer system would have a “Purchasing and Tracking System” to do the following:

1. Provide a data base system to be drawn upon for each new purchase document

2. For each purchase document it would provide:

a. A purchase worksheet for backup data supporting the order.

b. A copy of the one page order

c. A program to have each approver send a copy of the order to the next location.

d. A program to have the recipient return the approved copy, updating the preceding base copy (and any action data added)

e. A program to set a delivery time schedule with an alarm signal for time failures.

f. A program to send an updated copy of the completed stages to storage at a different location.

g. A program to read the account numbers from the order for the amounts to be processed into the accounting system when required, showing date of completion and reference data.

h. A program to transfer the order data to a statement to vendors

i. A program to set up the order document and the purchase worksheet in a permanent active file with number and vendor's identification.

j. A program to limit accessibility to these data.

C. Vendor Payment Program—would Include the Following Sub Programs

1. A program to group the orders for each vendor to be paid, listed by order number, vendor “invoice” number, and amount, with a cumulative total.

2. A program to balance the number of payments to be processed daily, from A 30 day period of payments due.

3. A program to select the payments to be scheduled each day.

4. A program to continuously list the specific vendor accounts to be processed on line, showing name, vendor's bank account identification, and amount to be paid.

5. A program for the company's bank to send this list to the company's bank for them to wire payments to the vendors' banks.

6. A program to have this list returned, with payment references.

7. A program to send copy of the vendor's payment statement to vendor.

8. A program to receive a daily bank statement showing previous day's cash activity with reconciliation done on the computer.

9. An accounting program to record the accounts payable and cash transactions, including vendors' accounts.

D. Permanent and Storage Files Programs—would Include the Following Sub Programs

1. Instructions for files systems

2. A program for programs

3. Retentions record schedule

4. Index of permanent file—by number, vendor and date

5. Index of storage file—by number, vendor and date

6. Computer file locations

7. Record of search inquiries

8. Record of permanent file restorations

9. Use as a percent of storage capacity

E. SECURITY AND Auditing Program—would Include the Following Sub Programs

These programs are designed to find errors and misuse of the existing systems, and recognize deficiencies in the systems. They will be performed by human effort, but assisted by computer programs which will be accessible at appropriate dates and unscheduled timing. Certain situations such as incorrect order numbers or unauthorized documents can be detected by the computer programs, producing an alarm for remedy. Much of the work would be done on a test basis.

1. Control of number system

2. Signals which numbers aren't accounted for.

3. Checking for lack of authorizations

4. Checking for improper changes in order details

5. Checking for existence of justifications.

6. Checking that orders are not padded with excess prices and quantities

7. Checking that merchandise ordered is received and used.

8. Checking that the amounts paid agree with the purchase document

9. Checking for collusion between employees or with vendors.

10. Checking that the amounts paid are reaching the right vendors.

11. Recognizing and preventing hackers attempting to disturb the system and divert funds.

12. Checking competitive opportunities being exercised for selection of vendors.

13. Checking that company policies and practices are being observed.

14. Checking that accounts are properly processed.

15. Checking that the system is functioning correctly with minimum of errors.

F Management Reports for Computer Programming

Responding to the management objectives of optimum profits and financial position, management information for purchasing centers around measuring performance to achieve; the right item, quantity, quality, price, timing, warranty, credit terms and sources, at the right cost of performing the function of purchasing.

Each of these requirements can be related to specific product needs for evaluation, plus measuring the cost of purchasing.

Programs can be introduced to:

1. List sales products by those which have the highest percent of purchased raw materials of their total cost, showing the percent and dollar size of the material cost, along with unit cost of the materials, comparing prior periods—accompanied by action notes

2. Lists annual purchases showing large dollar items by types of use and organizational use, arrayed by dollar size,—also annual purchases by major vendors—accompanied by action notes.

3. List major purchases by percent increase in unit costs over previous Year—accompanied by action notes.

4. List those groups of items, or large items which represent the largest share of the recent inventory compared with a prior period—accompanied by action notes

5. List those items (by significance) which have reduced in price since last year, with percentage reduction and dollar savings,—accompanied by notes.

6. List those (by significance) which have increased in price since last year, with percentage increase and dollar cost—accompanied by notes.

7. Report the split between purchases for fixed assets and expense, for a representative period, with significant details.

8. Report on purchasing errors for previous quarter, by types, responsibility, and cost. Accompanied by action notes

9. Report on comparative costs of purchasing operations, by type of function and responsibility, with production figures—accompanied by action notes

10. Average number of orders issued daily by the purchasing department

11. Average daily operating cost of the department

12. Average cost per order

13. Number of orders issued per employee each month

14. Number of late deliveries from vendors

15. Percentage of deliveries having errors

16. Number of complaints on resale products

17. Number of complaints from vendors.

The Basic Claim

1. An electronic computer system to be adopted by the purchaser, vendor and bank, introducing a one page business document which travels electronically to and between participants in ordering, purchasing, shipping, receiving and paying for merchandise secured by a purchasing organization from a vendor, and paying to the vendor's bank. The system eliminates conventional purchase requisitions, purchase orders, order confirmations, invoices, vendor's statements, and payment checks, through an electronic action controlled step program.
Supporting Claims

2. The document contains all the necessary data for directing and supporting these actions through a control system, thereby providing quick reference for all participants, and use in auditing the purchasing transactions.

3. An electronic control system serves to schedule the delivery of the merchandise on the basis of the requested delivery date, allowing time for delivery, and providing a supporting system for timing and content problems to be solved through an electronic Action Change Request, coupled with an open tracking system which continually follows the timing and completion of the several action steps, for possible awareness of delays and the need for corrective action.

4. Although the vendor's invoices are eliminated in the system, the vendors would continue to control shipments with “invoice” numbers relating to the purchaser's order documents. This number would be inserted in the purchaser's document by the vendor, to enter the system and would recognize the vendor's acceptance of the purchase contract, as noted on the bottom of the order form. Thus, at this point, the document also takes on the form of an invoice. Possibly the vendor might use an electronic signature to also approve the order, as provided in the document, if convenient for the vendor.

5. Approvals by the purchaser's participants in the system are identified by electronic signatures.

6. The usual control of billing by the vendor for the items shipped, is replaced by the purchaser paying the vendor only for the acceptable items received, and confirming the identification of the related vendor's invoice numbers being paid, to the vendor.

7. The shift in control provides the purchaser an opportunity to arrange a 30 day payment schedule with each vendor to balance all the vendors' payments to fit into the purchaser's cash flow position.

8. Through each document being programmed to show the exact amount to be paid the vendor for the 30 day period, this is in the computer payment system and the computer instructs the purchaser's bank to send this amount to the vendor's bank, as scheduled, without any individual's participation, except as an audit and security measure.

9. Although the system is basically designed for an in house installation, the purchasing organization could outsource any or all of the program to other organizations.

10. Worksheets are made part of the system to justify the purchase of significant items and provide possible backup data. It travels with the document prior to approving the order to the vendor. It is held in suspense until the payment is made, when it is combined with the document, in the stored data banks for fixed assets, inventories, and expenses, available for reference and auditing.

11. A worksheet is available for contract orders, or frequent large orders from specific companies to keep track of the orders to date, performance of vendor, contract dates, etc. This can be used in anticipation of a new order, or for a periodic review, and when renewing contracts. Data would be brought up to date upon receipt of each order.

12. A section is provided on the document to show the account (s) to be charged for the items purchased, which is entered into the system when preparing the document and held in suspense until the items are received, as acknowledged, and an accounts payable is set up.

13. The system lends itself to easily make the necessary accounting entries electronically, using the amounts, process steps and data available on the document.

14. A list of 17 different management control reports is offered as possible assists in the management of the purchasing functions—to be used at different time schedules.

15. The vendor, in benefiting from the program, would put a “stop” on the printing, handling and mailing of the purchase confirmation, invoice, statement, and shipping document normally sent the purchaser. Vendor would just insert an invoice number in the purchase document, followed by clicking the next action circle, returning it to the purchaser's system. Vendor would prepare a shipping label to place on the shipment showing address, with document and invoice numbers. At first contact with the purchaser, vendor would provide wire payment instructions to send the payment directly to vendor's bank. Vendor can use purchaser's document to transfer order data to their own records.

16. The purchaser's bank, in benefiting from the program, would have a direct line with the Purchaser to supplement the bank's system for handling wire transfers to vendors. Working on a daily batch basis, the purchaser's system wires the bank a cash transfer authorization for the bank's payment account to process all the payments to be made by wire that day—on an imprest basis, with a listing and wire directions for making vendor payments. At the end of the day, the bank wires the purchaser's system a reconciliation with an electronic signature confirming that all payments were sent, and any exceptions.
